(19) United States
(12) Patent Application Publication
(10) Pub. No.: US 2026/0050273 A1
(43) Pub. Date: Feb. 19, 2026

(54) Valve arrangement, actuator device and method for actuating a valve arrangement

(71) Applicant: Festo SE & Co. KG, Esslingen (DE)

(72) Inventors: Jian Zhang, Filderstadt (DE); Andreas Hiller, Esslingen (DE); Wolfgang Schuefer, Stuttgart (DE); Sebastian Mueller, Walddorfhaeslach (DE); Robert Irsigler, Goeppingen (DE); Joshua Niklas Frank, Uhingen (DE); Sven Ebeling, Denkendorf (DE)

(73) Assignee: Festo SE & Co. KG, Esslingen (DE)

(21) Appl. No.: 19/302,355

(22) Filed: Aug. 18, 2025

(30) Foreign Application Priority Data
Aug. 19, 2024 (DE) 10 2024 123 607.8

(51) Int. Cl. G05D 7/06

(52) U.S. Cl. CPC G05D 7/0652

(57) ABSTRACT

The invention relates to a valve arrangement and a method for actuating a valve arrangement having a 2/2-way proportional valve and a switching valve. The valve arrangement receives a single control signal and generates individual actuation signals from this control signal for the individual valves of the valve arrangement.

This application claims priority to the filing date of German patent application number 10 2024 123 607.8, filed Aug. 19, 2024, the disclosure of which is hereby incorporated by reference.

The present invention relates to a valve arrangement, in particular a valve arrangement having a combination of a 2/2-way proportional valve and a switching valve. The present invention further relates to an actuator device, in particular a fluid-controlled actuator device, having such a valve arrangement, The present invention further relates to a method for actuating a valve arrangement.

Various types of valves can be used to control fluid flows, such as liquids or gases, in particular compressed air. On the one hand, so-called switching valves are known. Such switching valves can usually have two defined states, for example open or closed. The desired switch position can be signalled to the switching valve, for example, via a binary actuation signal.

On the other hand, so-called proportional valves are known. Such proportional valves or continuous-action valves do not only enable discrete switch positions, such as fully open or closed, but also a steady transition of the valve opening. The desired setpoint for the state of such a proportional valve can, for example, be signalled via an analogue actuation signal in the form of a current or voltage value.

If a closed volume is to be filled and emptied with a fluid in a controlled manner, this can be done, for example, by an arrangement having two valves. A first valve can, for example, be provided between a fluid source and the volume. Thus, by opening this first valve, the fluid can be discharged from the fluid source into the volume in a controlled manner. A second valve can, for example, be provided between the volume and an outlet. As a result, the fluid can be discharged from the volume in a controlled manner by actuating this second valve in a controlled manner.

However, the disadvantage of this is that both valves of such an arrangement have to be individually supplied with suitable actuation signals. For this purpose, two separate, coordinated control signals have to be generated and provided by an external control unit for such an arrangement.

There is therefore a need for a cost-effective, reliable and easy-to-actuate valve arrangement having a plurality of valves, which makes it possible to individually control the plurality of valves on the basis of a single signal or a single specification.

The present invention creates a valve arrangement, an actuator device and a method for actuating a valve arrangement having the features of the independent claims. Further advantageous embodiments are the subject of the dependent claims.

According to one aspect, a valve arrangement is provided. The valve arrangement comprises a 2/2-way proportional valve, a switching valve and a control device. The 2/2-way proportional valve is connected at one port to an application port. The switching valve is also connected at one port to the application port. The control device comprises a setpoint interface, a first actuation interface and a second actuation interface. The setpoint interface is designed to receive a setpoint, in particular a control signal for a setpoint. The first actuation interface is designed to output a first actuation signal. The first actuation signal is in particular suitable for actuating the 2/2-way proportional valve. The second actuation interface is designed to output a second actuation signal for actuating the switching valve. The control device is further designed to generate the first actuation signal for actuating the 2/2-way proportional valve and the second actuation signal for actuating the switching valve using the same received setpoint or the same control signal for the setpoint.

According to another aspect, an actuator device, in particular a fluid-controlled actuator device is provided. The actuator device comprises at least one actuator and a valve arrangement, as described above. The actuator device or actuator is designed to perform an actuation by means of the valve arrangement. The actuation can in particular be performed using a fluid flow and/or a pressure of the fluid, with which the valve arrangement is actuated. The application port of the valve arrangement is coupled to a fluid port of the at least one actuator. In particular, the application port of the valve arrangement and the fluid port of the actuator are coupled to one another in such a way that fluid exchange is possible. The actuator device can be designed for different applications, such as for gripping tasks, for filling and/or emptying tasks.

According to another aspect, a method for actuating a valve arrangement, as described above or below, is provided. The valve arrangement can in particular be a valve arrangement having a 2/2-way proportional valve and a switching valve. The 2/2-way proportional valve can be connected at one port to an application port. Furthermore, the switching valve can also be connected at one port to the application port. In particular, the valve arrangement can be a valve arrangement according to the first aspect. The method comprises a step for receiving a setpoint or a control signal for a setpoint. Furthermore, the method comprises a step for determining a first actuation signal for actuating the 2/2-way proportional valve. The first actuation signal can in particular be determined using the received setpoint or control signal for the setpoint. Furthermore, the method comprises a step for determining a second actuation signal for actuating the switching valve. The second actuation signal can in particular be determined using the received setpoint or control signal for the setpoint. The first actuation signal for actuating the 2/2-way proportional valve and the second actuation signal for actuating the switching valve can be generated using the same received setpoint or control signal for the setpoint. Finally, the method comprises a step for outputting the first actuation signal to the 2/2-way proportional valve and the second actuation signal to the switching valve.

The present invention is based on the realisation that, for example, for the actuation of an actuator using a fluid flow or a fluid pressure, both the inflow of the fluid and the outflow of the fluid have to be controlled. For this purpose, either complex and costly 3/2-way valve arrangements can be used, or alternatively valve arrangements having a plurality of separate 2/2-way valves. However, valve arrangements having a plurality of separate 2/2-way valves (which may be combined with a switching valve) require precisely coordinated actuation of all valves involved. In particular, a separate, individual actuation signal must be provided for each valve involved. It is therefore not enough when using such valve arrangements for a superordinate external control device to merely transmit a single control signal with a setpoint for the actuator to be actuated to the valve arrangement. Rather, in this case, the superordinate control device has to generate an individual actuation signal for each valve involved. For this purpose, the superordinate external control device must be individually configured according to the system characteristics of all valves, depending on the valve arrangement used. This results in high demands for the superordinate external control device and also requires, depending on the valve arrangement used, an individual configuration which usually has to be carried out manually by a user prior to commissioning.

Based on this, it is therefore an idea of the present invention to create a concept for a simple, reliable and cost-effective valve arrangement, which makes it possible to control the inflow and outflow of fluid flows on the basis of a single control signal or setpoint. For this purpose, it is provided to create a valve arrangement, which makes it possible to control a plurality of valves in the valve arrangement on the basis of just a single control signal. The individual valves of such a valve arrangement can be different in design. In particular, proportional valves can be combined together with switching valves in such valve arrangements. One particular feature of such valve arrangements is that for the individual valves of such a valve arrangement, an individual actuation signal is generated and provided for each valve of the valve arrangement on the basis of a single control signal received.

A control signal for such a valve arrangement can in particular be understood as any suitable type of signalling, such as a signal for specifying a setpoint. The control signal can, in principle, be provided in any way. For example, the control signal can be provided in the form of an analogue signal, such as a voltage or current signal, in particular an analogue signal within a predefined value range. Alternatively, the control signal can also be transmitted in the form of a digital signal, for example by transmitting a digital value with one or more bytes. In particular, such a digital signal can, for example, be transmitted via a suitable bus system or the like.

The setpoint, which can be provided in particular at the valve arrangement, can, in principle, relate to at least any one suitable parameter that characterises the function (opening/closing) and/or state (partially or fully open or partially or fully closed) of at least one valve of the valve arrangement and preferably all valves of the valve arrangement, in particular of the 2/2-way proportional valve and switching valve. For example, such a setpoint can specify a pressure or a flow rate of a fluid, which is to be set by the valve arrangement. However, setpoints relating to other parameters in connection with the fluid controlled by the valve arrangement are also possible in principle. If, for example, an actuator is to be actuated by the fluid, the provided setpoint can also relate to a state of this actuator. In this case, this setpoint can be converted into corresponding parameters for the fluid, such as a pressure or a volume flow of the fluid, by the valve arrangement, in particular the control device of the valve arrangement.

The setpoint preferably comprises a specification for at least one parameter of the overall valve arrangement, comprising at least two valves of different types. Alternatively, the setpoint comprises a specification for an actuator device actuated with the valve arrangement.

The setpoint interface can be designed to receive a control signal for a setpoint. The term “control signal for a setpoint” can be understood as a control signal that represents or encodes a setpoint. The setpoint comprises in particular a specification for all valves of the valve arrangement and/or a specification for the valve arrangement and/or a specification for the actuator arrangement, which is actuated with the valve arrangement (e.g. specification for a gripper).

The valve arrangement can comprise at least two valves, in particular at least two different valves, i.e. different valve types. The valve arrangement can thus, for example, be composed of different valve types and can in particular comprise a combination of a switching valve, in particular a fast-switching valve, and a proportional valve, in particular a 2/2-way proportional valve. A switching valve is to be understood as a valve that can be switched between two discrete states. For example, a switching valve can be switched between an open state and a closed state. In the open state, a fluid can flow largely unobstructed between two ports of the valve. In the closed state, the fluid flow between the two ports of the valve can be interrupted. In order to actuate such a switching valve, a binary actuation signal in the form of a suitable voltage or current signal can be provided to the switching valve, for example. If the actuation signal is in a first value range, for example, the switching valve assumes a first state, for example closed. If the actuation signal is in a second value range, for example, the switching valve assumes a second state, for example open. However, in principle, switching valves are also conceivable which respectively switch back and forth between two states when a predetermined actuation signal is applied.

A proportional valve in accordance with the present invention is to be understood as a valve which not only enables two discrete switch positions, but rather also a steady transition between a fully closed state and a fully open state. The desired state of such a proportional valve can, for example, be signalled via a suitable actuation signal, such as an analogue actuation signal in the form of a current or voltage value. A 2/2-way proportional valve only has two ports, for example an inlet and an outlet.

The valve arrangement can be designed for any technical application. For example, the valve arrangement can comprise the combination of a 2/2-way proportional pressure control valve and a switching valve. Air can be supplied by the proportional valve, for example. A switching valve can be used for extracting air, for example. The two valve types can also be used the other way round for the two tasks. The regulation is designed so that no overshoot occurs during air supply. Both valves are connected to the control system of the customer by an interface, in particular the setpoint interface.

The combination of a proportional air supply function and an unregulated air extraction function has a plurality of advantages. For example, dispensing with the second proportional valve for air extraction results in cost savings (dispensing with a piezo bending element or, for example, a proportional magnet). This also results in a smaller installation space due to the more compact installation space of the switching valve. In the de-energised state, air extraction is ensured by the use of a NO valve.

The embodiment with the combination of an air supply proportional valve with an air extraction switching valve has been described above. Even though it can be assumed that in practice air supply will often be carried out via the proportional function, in an alternative embodiment, air supply can be provided via a switching valve and air extraction via a proportional valve.

The control device of the valve arrangement is designed to generate an individual actuation signal for each valve of the valve arrangement from the received control signal for the setpoint. The individual actuation signals can then be supplied to the individual valves in a suitable manner. For this purpose, the control device can, for example, comprise a suitable electronic circuit in the form of discrete components, such as resistors, capacitors, transistors, integrated circuits or the like. Moreover, the control device can also at least partially by implemented by a microcontroller or the like. For example, a code for a computer program can be provided in a memory communicatively coupled to the microcontroller, which causes the microcontroller to carry out the required processing steps.

According to one embodiment, the control signal for the setpoint can comprise an analogue voltage or current signal. For example, the setpoint can be signalled by a control signal as a voltage signal within a predefined value range, for example between 0 and 5 V, 0 and 10 V, 0 and 12 V, preferably between 0 and 10 V, or another suitable value range. Alternatively, the setpoint can, for example, also be signalled by a current signal, for example in a value range between 4 and 20 mA. In this way, such an analogue signal can be used to signal the respective setpoint by means of a suitable mapping between the value range of the control signal and a value range of the setpoint of the valve arrangement, in particular the control device. However, it is also alternatively possible to provide the setpoint by suitable digital data transmission to the control device of the valve arrangement. For this purpose, a suitable bus system, such as a CAN bus or the like can be used, for example.

The control device can be designed to calculate or produce a mapping between received control signals and the respective, potentially plurality of, actuation signals. The mapping can be understood as a conversion rule for converting the (current and/or voltage) signal into a setpoint. The conversion rule can be defined via a user interface (UI) and/or be different for the respective setpoints for the respective valves of the valve arrangement. The setpoint can characterise a target state of a valve of the valve arrangement.

According to one embodiment, the control device is designed to actuate the switching valve if the control signal for the setpoint exceeds a first threshold. In this case, the control device can further be designed to actuate the 2/2-way proportional valve if the control signal for the setpoint exceeds a second threshold. The second threshold can in particular be greater than the first threshold. With this type of circuit design, when the first threshold is exceeded, the switching valve is thus initially actuated, for example closed. Furthermore, if there is a further increase in the control signal above the second threshold, the other vale, in particular the 2/2-way proportional valve, can be actuated. The proportional valve can in particular be actuated depending on the current value signalled by the control signal. For example, an actuation signal can be provided to the proportional valve which results from a difference between the current value from the control signal and an offset, for example the second threshold. Such a concept thus makes it possible, for example, to generate both a suitable actuation for the switching valve and for the proportional valve from a single control signal.

According to one embodiment, the 2/2-way proportional valve is arranged between a fluid inlet and the application port. Furthermore, the switching valve can be arranged between the application port and a fluid outlet. Thanks to such a configuration of the individual valves in the valve arrangement, the inflow of a fluid can be continuously adjusted within the control range of the proportional valve, for example. Furthermore, the switching valve at the fluid outlet can be used to block or release the outflow of the fluid. In particular, the use of a switching valve at the fluid outlet enables very rapid discharge of the fluid when the switching valve is open.

According to one embodiment, the switching valve is designed as a normally open valve (NO valve). Such an NO valve corresponds to a valve that is open without active actuation or actuation below a threshold. If an active actuation signal is provided to such an NO valve, this valve can switch to a closed or blocking state. The use of such an NO valve can ensure that even in the switched-off state, for example in the event of a fault caused by a line interruption or the like, the valve transitions to a defined state, thereby establishing a safe operating state for the valve arrangement. For example, with an NO valve at the fluid outlet it can be ensured that the valve enables discharge of the fluid in the non-actuated state. This can help to prevent potentially dangerous operating states. Alternatively, depending on the application and configuration of the individual valves, an NC valve (normally closed valve) can also be provided.

According to one embodiment, the valve arrangement comprises a configuration device. The configuration device can be designed to set the first threshold and/or the second threshold and/or define the conversion rule (in particular analogue voltage or current control signal into actuation signal). The valve arrangement can be easily and very efficiently adapted for different applications thanks to such dynamic adjustment of the first and/or second threshold and/or conversion rule. For example, it is possible on the one hand to adjust a predefined valve arrangement for connection to different sources for the control signal with the setpoint by adjusting the thresholds. In particular, as a result, a valve arrangement can easily be adjusted for connection to different external sources, for example different manufacturers or different models of a manufacturer. Furthermore, if the valve arrangement is replaced, for example following a fault or the like, it is also possible thanks to such a configuration device to very easily adapt the new valve arrangement to the respective operating conditions through appropriate configuration.

The configuration device can, for example, comprise switching elements, such as DIP switches, jumper pins, such as jumper elements, or any other configuration elements that can be manually actuated. As a result, a user can very easily carry out the respective configuration. In particular, when a valve arrangement is being replaced, the user can easily visually detect the configuration of the previous valve arrangement and transfer it to the new valve arrangement, for example. However, in principle, the configuration can also take place in any way. For example, the configuration can also take place through digital communication. Another configuration interface may be provided for this purpose. Alternatively, it is also conceivable to transmit the configuration or parameterisation via the setpoint interface, for example. For this purpose, the valve arrangement and in particular the control device can, for example, be switched to a configuration mode by suitable measures, such as actuating a switch or the like. The corresponding interface can then receive the configuration data and, for example, store it in a non-volatile memory. Of course, any other suitable measures for configuration, in particular of the first and/or second threshold, are also possible.

According to one embodiment, the valve arrangement comprises at least one sensor. The sensor can, for example, be a pressure sensor and/or a temperature sensor. The sensors(s) can be designed to detect an operating parameter in the valve arrangement by means of sensors. In this case, the control device can, for example, be designed to adjust the actuation of the 2/2-way proportional valve and/or switching valve using the operating parameters detected by means of sensors. In addition or alternatively, the control device can also be designed to detect a malfunction in the valve arrangement using the sensor data provided by the sensor(s). In this way, the operating behaviour and reliability of the valve arrangement can be further optimised thanks to the integration of the sensors and evaluation of the sensor data. For example, the pressure or volume flow of a fluid through the valve arrangement can be adjusted by adjusting a characteristic curve for the proportional valve depending on the operating parameters. As a result, fluctuations in the pressure or volume flow can, for example, be compensated for and therefore the pressure or volume flow can be regulated in accordance with the desired setpoint even under fluctuating conditions.

According to one embodiment, the application port is designed to be coupled to an actuator. Accordingly, the actuator can be actuated using a fluid provided at the application port. The actor can, in principle, be any actuator that can be actuated using a fluid. For example, the actuator can be a retaining element, a gripper or the like, with which a pressure is to be exerted on a component or the like to be retained by means of the fluid, such as compressed air. Furthermore, the actuator can, for example, be a metering device with which a substance to be metered is to be dispensed in a controlled manner by means of the fluid. However, it is understood that in principle, any other actuators are also possible depending on the application.

The setpoint interface can be designed to receive data, in particular a control signal for a setpoint. The setpoint interface can alternatively be designed to additionally output data, for example for verification. The setpoint interface can comprise a user interface, for example in order to adjust the control signal and/or setpoint.

The actuation interface can comprise a first and a second part, namely a first and second actuation interface. The actuation interface can be designed to output data, in particular a first and second actuation signal for actuating the respective valve of the valve arrangement. The actuation interface can alternatively be designed to additionally read in data, for example status data of the valve, in order to enable regulation of the valve of the valve arrangement.

The above features, embodiments and further developments can, where appropriate, be combined with one another in any way (even if this is not explicitly stated). Other potential embodiments, further developments and implementations of the invention also include not explicitly mentioned combinations of features of the invention described above or below in relation to the exemplary embodiments. In particular, a person skilled in the art will also add individual aspects as improvements or additions to the respective basic form of the present invention.

In particular, features of the method claims can be implemented and/or carried out by corresponding components of the control device, whereby these supplement or extend its functionality and vice versa. The skilled person will thus also refer to aspects of the method claims for the control device.

The invention has been largely described above with reference to the device or valve arrangement. Aforementioned features, advantages or alternative embodiments can also be applied to the other claimed subjects, and in particular to the method, and vice versa. In other words, the claims in question (which relate, for example, to a valve arrangement or an actuator device) can also be further developed with the features described or claimed in connection with the method and vice versa. The corresponding functional features of the method are embodied by corresponding modules, in particular by hardware modules or microprocessor modules, of the system or product and vice versa. The alternatives or embodiments of the invention described in connection with the method are not explicitly repeated for the device, but can also be applied within the scope of the device. Generally speaking, in computer science, a software implementation and a corresponding hardware implementation (for example as an embedded system) are equivalent. For example, a method step for “storing” data can be carried out using a memory unit and corresponding instructions for writing data into the memory. In order to avoid unnecessary repetition, features or aspects of the device are therefore not explicitly described again although they can also be used in the alternative embodiments described with reference to the method. In principle, the claimed device is designed to carry out the claimed method.

### BRIEF DESCRIPTION OF THE FIGURES

Non-limiting exemplary embodiments are discussed with their features and further advantageous with reference to the drawing in the following detailed description of the figures.

In the drawing:

FIG. 1: shows a schematic representation of a block diagram of a valve arrangement according to one embodiment;

FIG. 2: shows a schematic representation to illustrate the switching behaviour of a valve arrangement according to one embodiment;

FIG. 3: shows a schematic representation to illustrate an actuator device having a valve arrangement according to one embodiment;

FIG. 4: shows a schematic representation of a valve arrangement according to one embodiment in a first operating state;

FIG. 5: shows a schematic representation of a valve arrangement according to one embodiment in another operating state; and

FIG. 6: shows a flow chart, based on a method for actuating a valve arrangement according to one embodiment.

The appended drawings are intended to provide further understanding of the embodiments of the invention. They illustrate embodiments and serve to explain the principles and concepts of the invention in connection with the description. Other embodiments and many of the advantages mentioned result from the drawings. The elements in the drawings are not necessarily shown to scale.

Identical, functionally identical and identically acting elements, features and components respectively bear the same reference numerals in the figures of the drawing, unless otherwise stated.

### DETAILED DESCRIPTION OF THE INVENTION

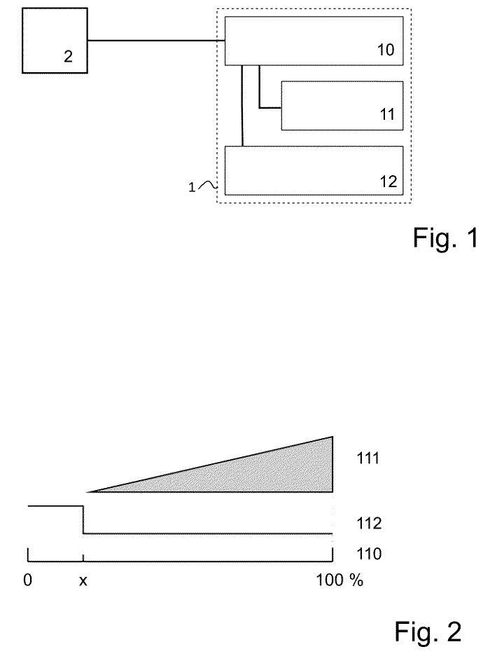

FIG. 1 shows a schematic representation of a block diagram to illustrate the basic principle of a valve arrangement 1 according to one embodiment. The valve arrangement 1 comprises a control device 10, a 2/2-way proportional valve 11 and a switching valve 12. The control device 10, proportional valve 11 and switching valve 12 of the valve arrangement 1 are preferably designed as a common assembly.

The proportional valve 11 and switching valve 12 can be valves with two ports each, for example a fluid inlet and a fluid outlet. Depending on the application, the proportional valve 11 and switching valve 12 are designed to control a corresponding fluid, such as a liquid, for example water, a hydraulic fluid or the like and/or a gaseous medium, such as air, in particular compressed air.

The switching valve 12 is able to switch between a fully open state and a fully closed state. For this purpose, a corresponding—in particular second—actuation signal can be provided to the switching valve 12. The second actuation signal (hereinafter simply referred to as: actuation signal) can, for example, be a voltage-controlled or current-controlled actuation signal. For example, with an actuation signal below a predetermined first threshold, for example below a predetermined first voltage or current value, the switching valve 12 can assume a first switching state, for example open. Furthermore, with an actuation signal above a predetermined second threshold, for example above a predetermined second voltage or current value, the switching valve 12 can assume a second switching state, for example closed. There may be an undefined range between the first threshold and the second threshold. However, in principle it is also possible to define the same value for the first threshold and second threshold.

The switching valve 12 can, for example, be an NO (Normally Open) valve. Such a valve is open provided that it is not actively actuated, i.e. when there is no actuation signal above a defined threshold, for example. Alternatively, the switching valve 12 can also be an NC (Normally Closed) valve, which is closed when not actively actuated.

Moreover, in principle, depending on the application, switching valves may also be possible, which respectively switch back and forth between an open and a closed state when a predefined switching pulse is applied (toggle valves).

In addition to the discrete states for complete opening and complete closing, the 2/2-way proportional valve 11 also enables a steady transition of the valve opening. In this way, a flow of a fluid through such a proportional valve 11 can be adjusted within the available range of the proportional valve 11. For this purpose, for example, the degree of opening of the proportional valve 11 can be adjusted depending on an in particular first actuation signal provided to the proportional valve 11. For example, the degree of opening of the proportional valve 11 can be varied depending on the voltage level or current of a first actuation signal (hereinafter simply referred to as actuation signal) present. For this purpose, for example, a value range can be defined for the actuation signal, wherein the proportional valve 11 can be fully closed at one end of the value range and fully open at the other end of the value range. In between, the degree of opening of the proportional valve can be varied linearly, logarithmically, exponentially or according to any other characteristic curve depending on the magnitude of the actuation signal present.

The control device 10 can, on the one hand, be coupled to an external signal source 2. For this purpose, a setpoint interface 10a can be provided in the control device 10, for example. The control device 10 can, for example, receive specifications for a setpoint, in particular a control signal for a setpoint, via this setpoint interface 10a. This setpoint can be any value, in particular any value in connection with properties for a fluid flow through the valve arrangement 1. For example, the setpoint can be a value which specifies a pressure or volume flow for the fluid to be set by the valve arrangement 1. The setpoint may also characterise a characteristic feature of a component connected to the valve arrangement, such as an actuator or the like, in particular a characteristic feature which can be influenced by the fluid, for example the pressure or volume flow of the fluid. However, in principle, the setpoint provided via the control signal to the control device 10 can also comprise any other property or any other parameter, in particular a property or parameter in connection with the fluid which flows through the valve arrangement 10.

The setpoint can characterise the function and/or state of the valve arrangement 1. The setpoint can alternatively or cumulatively comprise a specification for the unit moved by means of the valve arrangement 1.

The setpoint can be signalled at the setpoint interface 10a of the control device 10 in any suitable manner. For example, the setpoint can be provided in the form of an analogue, in particular in the form of an analogue current or voltage signal. However, in principle, the setpoint can also be transmitted in the form of a digital control signal, for example in the form of a data element. For this purpose, a bus system, such as a CAN bus or the like is possible, for example. However, depending on the application, the setpoint can also be provided to the control device 10 in any other manner.

The control device 10 further comprises a first actuation interface 10b and a second actuation interface 10c. The first actuation interface 10b can, for example, be coupled to the 2/2-way proportional valve 11. In this way, a suitable actuation signal, for example in the form of a current or voltage signal, can be provided by the control device 10 to the proportional valve 11. In the same way, the second actuation interface 10c can be coupled to the control valve 12. In this way, a suitable actuation signal, also for example in the form of a current or voltage signal, can be provided by the control device 10 to the control valve 12. The specific characteristics of the actuation signals for the proportional valve 11 and control valve 12, as provided by the control device 10, can be adapted in accordance with the specifications of the proportional valve 11 and control valve 12.

The control device 10 is able to process the received control signal for the setpoint and generate therefrom the suitable actuation signals for the proportional valve 11 and switching valve 12. It is thus possible to actuate all valves, in particular the proportional valve 11 and switching valve 12, of the valve device 1 individually on the basis of a single control signal, namely the control signal at the setpoint interface 10a. One possible concept for an embodiment for generating the actuation signals on the basis of the setpoint specification is explained in more detail below.

The control device 10 can, for example, be implemented by an electronic circuit with discrete components, such as resistors, capacitors, diodes, transistors, integrated circuits, or the like, for example integrated on a printed circuit board. In addition or alternatively, the control device 10 can also comprise an application-specific integrated circuit, a microcontroller or the like, in order to implement at least part of the functionalities of the control device 10. For this purpose, for example, a memory can be provided which contains a program code which can be loaded and executed by a processor.

The control device 10 can preferably be mounted on the valve arrangement. For example, the control device 10 can be arranged in the vicinity of the valves of the valve arrangement or in the vicinity of the electrical connection of the valve arrangement.

FIG. 2 shows a schematic representation to illustrate an option for implementing the setpoint specification in actuation signals for the proportional valve 11 and switching valve 12. At the bottom, reference numeral 110 shows the possible value range for the setpoint transmitted to the control device 10 by the control signal. Above it, reference numeral 112 shows the switching state desired for the respective setpoint or the corresponding actuation signal for the switching valve 12. As shown, the state of the switching valve 12 changes at a value x of the setpoint specification. Below this value x, the switching valve 12 is in a first state, for example open. Above the value x, the switching valve 12 is in a second state, for example closed.

Furthermore, reference numeral 111 shows the resulting actuation signal for the proportional valve 11. In the example shown here, the proportional valve 11 is not actuated with a setpoint smaller than or equal to x. If the setpoint specification rises above the value x, an increasing actuation signal is provided to the proportional valve 11 as the setpoint specification increases. The proportional valve 11 can be fully open at a setpoint specification of 100%, for example. However, in principle, the start of an actuation signal for the proportional valve 11 deviating from zero does not necessarily have to coincide exactly with the value for the setpoint specification for changing the switching state for the proportional valve 11. If applicable, different thresholds can also be set here depending on the application.

Thanks to such a scheme for determining a plurality of actuation signals for a plurality of valves, in particular for a proportional valve 11 and for a switching valve 12, on the basis of a single control signal, in particular a control signal representing a specification for a setpoint, the valve arrangement 1 can easily be connected to an external signal source 2 without the external signal source 2 having to generate a separate actuation signal for each valve 11, 12 of the valve arrangement 1 and provide it directly to the corresponding valves 11, 12. This can significantly simplify the connection of the valve arrangement 1 to an external signal source 2. In particular, the valve arrangement 1, and specifically the control device 10, can convert the control signal with the setpoint specification into the individual actuation signals for the individual valves 11, 12. As a result, there is no need to specifically adapt or configure the external signal source 2 to the individual characteristics or requirements of the valves 11, 12.

The diagram shown in FIG. 2 for generating the two actuation signals for the 2/2-way proportional valve 11 and switching valve 12 should, however, only be understood as an example. In principle, any other concepts, such as special characteristic curves, parameterisable configurations or the like are also possible for this purpose.

For example, the valve arrangement 1 and in particular the control device 10 can also comprise a configuration device (not shown in FIG. 1). Such a configuration device can define the value range for the setpoint or the setpoint specification of the control signal, for example. Alternatively or cumulatively, it is also possible to switch between a voltage-based and current-based control signal. Alternatively or cumulatively, it is possible, for example, for such a configuration device to adjust the actuation signals for the proportional valve 11 and/or switching valve 12. Here too, for example, the value range for the actuation signal can be set and/or it is possible to switch between voltage-based and current-based actuation signals. In this way, for example, when a valve 11, 12 in the valve arrangement 1 is replaced, the valve arrangement and in particular the generation of the actuation signals can be adjusted. Moreover, depending on the application, any other configurations or parameterisations are, of course, also possible.

For configuration by means of the configuration device, the configuration device can, for example, comprise one or more switching elements, such as DIP switches, jumpers or the like. As a result, a user can, for example, easily identify the switch position or the position of the jumpers. This makes it possible to easily transfer the corresponding configuration to another valve arrangement 1. Thus, for example, in the event of a replacement following a defect or the like, the present configuration can be very easily transferred to the new valve arrangement 1.

However, in principle, it is also possible to transmit the configuration, for example, to the control device 10 via a digital interface and store it in a preferably non-volatile memory. Another configuration interface may be provided for this purpose. Alternatively, it is also possible, for example, to transmit such a configuration in a special configuration mode by means of the setpoint interface 10a. For example, the control device 10 can be switched to such a configuration mode by actuating a corresponding switching element. A configuration or parameterisation can then be transmitted to the control device 10 and stored in the control device 10.

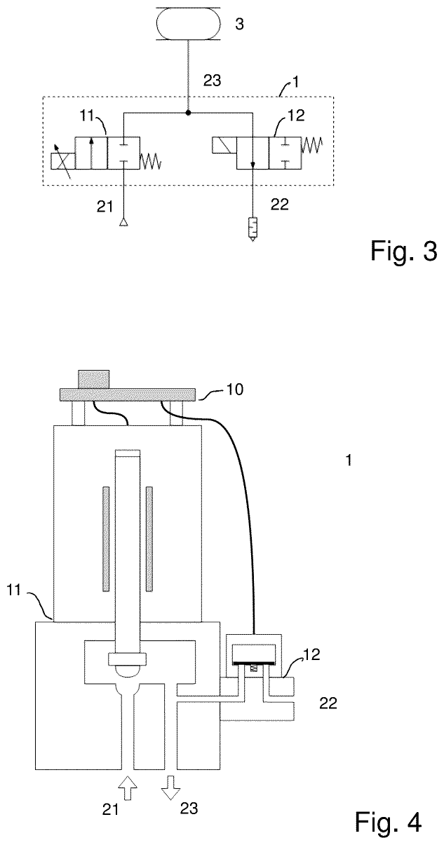

FIG. 3 shows a schematic representation of an actuator device having a valve arrangement 1 according to one embodiment. For a better overview, the control device 10 and the external signal source 2 are not shown in this figure. However, this does not constitute a limitation of the present invention in particular of this exemplary embodiment. Rather, all statements previously made in connection with FIGS. 1 and 2 also apply to the valve arrangement 1 in this exemplary embodiment.

The actuator device can, for example, comprise an actuator 3. This actuator 3 can be any actuator which carries out an actuation using a fluid, such as a liquid like water or a hydraulic fluid or a gas, such as air, in particular compressed air. For example, the actuator 3 can be a retaining device or a gripper, which exerts a force on an object to be held using a supplied fluid. In another example, the actuator 3 can, for example, be a metering device, which dispenses a substance to be metered in a controlled manner using a fluid provided. Moreover, any other fluid-based actuator applications are, of course, also possible.

The actuator 3 can, as shown in this exemplary embodiment, be connected to an application port 23 of the valve arrangement 1. The fluid can either flow in the direction of the actuator 3, or alternatively out of the actuator 3, via this application port 23.

Furthermore, a first valve, for example a 2/2-way proportional valve 11 can be provided between an inlet 21 of the fluid and the application port 23. At the inlet 21, the fluid can, for example, be supplied at a predetermined pressure. In this way, the inflow of the fluid from the inlet 21 to the application port 23 can be controlled by means of the proportional valve 11. For this purpose, the proportional valve 11 can be actuated by means of a suitable actuation signal. This actuation signal can in particular be generated according to the concept already described above on the basis of the control signal received by the control device 10.

Furthermore, another valve, for example a switching valve 12 is provided between the application port 23 and an outlet 22. If this switching valve 12 is closed, the fluid can flow from the inlet 21 through the proportional valve 11 to the application port 23. As a result, a desired pressure can be built up in the actuator 3 or a desired volume flow can be set, for example. If, on the other hand, the switching valve 12 is open, the fluid can be discharged in the direction of the outlet 22. As a result, any pressure in the actuator 3 can be rapidly reduced once the switching valve 12 is opened. In order to open or close the switching valve 12, a suitable actuation signal can also be provided by the control device 10 to the switching valve 12. This actuation signal can also be generated on the basis of the control signal for the setpoint received by the control device 10.

If the actuation signals for the proportional valve 11 and switching valve 12 are generated, for example, by the control device 10 in accordance with the concept shown in FIG. 2, then as the setpoint specification increases—in accordance with the control signal—the switching valve 12 is first closed when the the value x is reached. As the setpoint specification increases further, the proportional valve 11 is then continually further opened. In this way, both valves 11 and 12 of the valve arrangement 1 can be individually actuated on the basis of a single control signal. If, in further operation, the setpoint specification falls below the limit value x in accordance with the control signal, the switching valve 12 is then opened, wherein at the same time the proportional valve 11 is fully closed.

In addition to the components already described above, other components may be provided in the valve arrangement 1, in particular one or more sensors. A pressure of the fluid can, for example, be detected and monitored by means of such sensors. In such a case, it is, for example, possible to adjust the parameterisation for generating the actuation signals for the proportional valve 11 and/or switching valve 12 in accordance with the pressure currently detected. A control loop can thus be implemented. Fluctuations in the supply pressure of the fluid can thus, if necessary, be balanced out or at least partially compensated for. Furthermore, an operating temperature of the valve arrangement 1 and/or of the fluid can also be detected by means of one or more temperature sensors, for example. In this way, temperature-dependent fluctuations of the switching properties of the proportional valve 11 and/or switching valve 12 can be balanced out, for example. Furthermore, the detected pressure, monitored temperature or, if applicable, other recorded operating parameters in the valve arrangement 1 can be used to identify possible faults or malfunctions. For example, an error message can be issued when a limit value for a sensor value is exceeded or undershot. In addition or alternatively, the valve arrangement 1 can be switched to a predefined safe operating state in such an event of a fault.

FIG. 4 shows a schematic representation of a valve arrangement 1 according to one embodiment in a first operating state. The valve arrangement 1 is in an operating state in which a fluid can flow from the inlet 21 through the proportional valve 11 to the application port 23. The degree of opening of the proportional valve 11 can be set in accordance with the actuation signal present at the proportional valve 11. This enables the volume flow or pressure to be controlled at the application port 23 and an actuator 3 connected to this application port 23. The switching valve 12 between the application port 23 and the outlet 22 is closed.

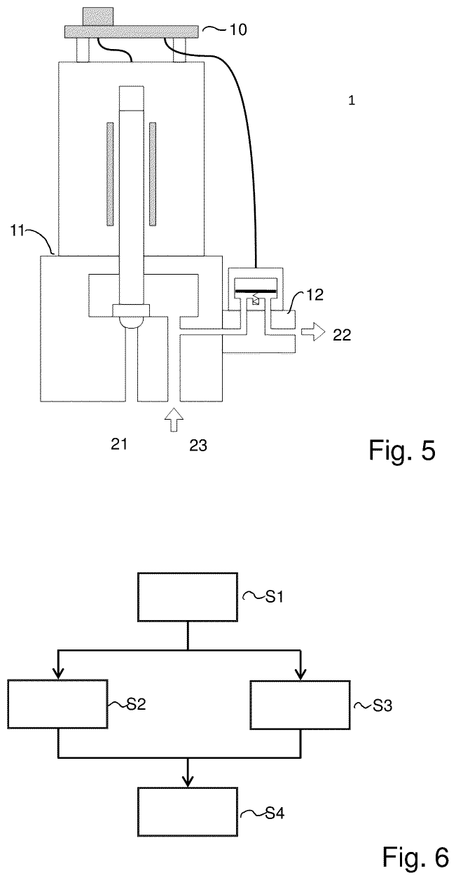

FIG. 5 shows a schematic representation of a valve arrangement 1 according to one embodiment in another operating state. In this operating state, the proportional valve 11 is fully closed whilst the switching valve 12 is open. The fluid can thus be discharged from the application port 23 in the direction of the outlet 22. In this way, a pressure in an actuator 3 at the application port 23 can be rapidly reduced.

FIG. 6 shows a flow chart that can form the basis of a method for actuating a valve arrangement 1, in particular a valve arrangement 1 described above having a 2/2-way proportional valve 11 and a switching valve 12 according to one embodiment. The method can, in principle, comprise any steps that are suitable for implementing a valve arrangement 1 or an actuator device having such a valve arrangement 1 described above. Similarly, the valve arrangement 1 or actuator device having such a valve arrangement 1 described above can comprise any components that are suitable for implementing the method described below.
In step S1, a control signal for a setpoint is received. The control signal can, for example, be received by a control device 10 of the valve arrangement 1, in particular a setpoint interface 10a of the control device 10.
In step S2, a first actuation signal for actuating the 2/2-way proportional valve 11 is determined. The first actuation signal is determined in particular using the received control signal for the setpoint.
In step S3, a second actuation signal for actuating the switching valve 12 is determined. The second actuation signal is also determined using the received control signal for the setpoint. In particular, the first actuation signal and the second actuation signal are respectively determined using the same received control signal for a setpoint.
Finally in step S4, the first actuation signal is output to the 2/2-way proportional valve 11 and the second actuation signal is output to the switching valve 12.

To summarise, the present invention relates to a valve arrangement and a method for actuating a valve arrangement, comprising a 2/2-way proportional valve and a switching valve. The valve arrangement receives a single or sole control signal and generates a plurality of individual (in particular first and second) actuation signals from this control signal for the individual valves of the valve arrangement.

REFERENCE NUMERALS

| | |
|---|---|
| 1 | valve arrangement |
| 2 | external signal source |
| 3 | actuator |
| 10 | control device |
| 10a, 10b, 10c | interfaces |
| 11 | proportional valve |
| 12 | switching valve |
| 21 | inlet |
| 22 | outlet |
| 23 | application port |
| 110 | setpoint specification |
| 111, 112 | actuation signals |
| S1-S4 | method steps |

1. Valve arrangement (1), having:
a 2/2-way proportional valve (11), which is connected at one port to an application port (23);
a switching valve (12), which is connected at one port to the application port (23);
a control device (10), having
a setpoint interface (10a), which is designed to receive a control signal for a setpoint,
a first actuation interface (10b), which is designed to output a first actuation signal for actuating the 2/2-way proportional valve (11), and
a second actuation interface (10c), which is designed to output a second actuation signal for actuating the switching valve (12),
wherein the control device (10) is designed to generate the first actuation signal for actuating the 2/2-way proportional valve (11) and the second actuation signal for actuating the switching valve (12) respectively using the same received control signal for the setpoint.

2. Valve arrangement (1) according to claim 1, wherein the control signal for the setpoint comprises an analogue voltage or current signal.

3. Valve arrangement (1) according to one of the preceding claims, wherein the control device (10) is designed to actuate the switching valve (12) if the control signal for the setpoint exceeds a first threshold, and to actuate the 2/2-way proportional valve (11) if the control signal for the setpoint exceeds a second threshold, wherein the second threshold is greater than the first threshold.

4. Valve arrangement (1) according to one of the preceding claims, wherein the 2/2-way proportional valve (11) is arranged between a fluid inlet (21) and the application port (23), and wherein the switching valve (11) is arranged between the application port (23) and a fluid outlet (22).

5. Valve arrangement (1) according to one of the preceding claims, wherein the switching valve (11) is designed as a Normally Open NO valve.

6. Valve arrangement (1) according to one of the preceding claims, having a configuration device, which is designed to set the first threshold and/or the second threshold.

7. Valve arrangement according to one of the preceding claims, having at least one sensor, in particular at least one pressure sensor and/or at least one temperature sensor, which is designed to detect an operating parameter in the valve arrangement (1) by means of sensors,
wherein the control device (10) is designed to adjust the actuation of the 2/2-way proportional valve (11) and/or switching valve (12) using the operating parameters detected by means of sensors and/or to detect a malfunction in the valve arrangement.

8. Valve arrangement (1) according to one of the preceding claims, wherein the application port (23) is designed to be coupled to an actuator (3), and to actuate the actuator (3) using a fluid provided at the application port (23).

9. Fluid-controlled actuator device, having:
at least one actuator (3), which is designed to perform an actuation using a fluid flow and/or a fluid pressure of a valve arrangement (1) according to one of the preceding claims;
wherein the application port (23) of the valve arrangement (1) is coupled to a fluid port of the at least one actuator (3).

10. Method for actuating a valve arrangement according to one of claims 1 to 8, having a 2/2-way proportional valve (11), which is connected at one port to an application port (23) and a switching valve (12), which is connected at one port to the application port (23), having the steps:
receiving (S 1) a control signal for a setpoint;
determining (S 2) a first actuation signal for actuating the 2/2-way proportional valve (11) using the received control signal for the setpoint;
determining (S 3) a second actuation signal for actuating the switching valve (12) using the received control signal for the setpoint, wherein the first actuation signal for actuating the 2/2-way proportional valve (11) and the second actuation signal for actuating the switching valve (12) are respectively determined using the same received control signal for the setpoint; and
outputting (S 4) the first actuation signal to the 2/2-way proportional valve (11) and the second actuation signal to the switching valve (12).
